(19) United States
(12) Patent Application Publication
(10) Pub. No.: US 2009/0169679 A1
(43) Pub. Date: Jul. 2, 2009

(54) Process for recovering aroma from tea

(75) Inventors: Vaswati Deka, Pune (IN); Anudeep Rastogi, Bangalore (IN); Gurmeet Singh, Bangalore (IN); Garima Vijay, Guwahati (IN)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a Unilever

(21) Appl. No.: 12/316,961

(22) Filed: Dec. 18, 2008

(30) Foreign Application Priority Data
Dec. 28, 2007 (IN) 2599/MUM/2007
Apr. 10, 2008 (EP) EP08154343

(51) Int. Cl. A23F 3/16

(52) U.S. Cl. 426/50; 426/52; 426/597; 426/655

(57) ABSTRACT

Disclosed is a process for recovering volatile aroma compounds from a tea material. The process comprises the steps of: incubating the tea material in an aqueous medium; subjecting the incubated tea material to evaporation to obtain aroma-laden vapours; and condensing the aroma-laden vapours to recover an aroma condensate comprising volatile aroma compounds. The tea material is subjected to a step of extraction of soluble solids prior to step (a) and the aqueous medium in step (a) comprises an enzyme selected from cellulase, pectinase, β-glucosidase, primeverosidase or a mixture thereof.

### TECHNICAL FIELD

This invention relates to the processing of tea. It particularly relates to recovery of volatile aroma compounds from a tea material.

### BACKGROUND OF THE INVENTION

Any discussion of the prior art throughout the specification should in no way be considered as an admission that such prior art is widely known or forms part of the common general knowledge in the field.

Aroma is a major organoleptic quality parameter of tea. The aroma of tea has a significant impact on the consumers' choice of tea and the commercial valuation of tea. Therefore, the improvement of tea aroma is an ongoing subject of research.

A large amount of volatile aroma compounds are known to be lost during processing. Various methods such as steam stripping, solvent extraction, supercritical carbon dioxide extraction, etc. have been used to recover volatile aroma compounds during tea processing. The recovered volatile aroma compounds are then sometimes added back to a tea product.

The process of aroma recovery is normally carried out after the step of extraction of soluble solids from tea leaves. The extracted liquor is evaporated to separate the extracted soluble solids from water, and the vapours generated during evaporation are condensed to recover volatile aroma compounds. This process results into relatively low yield as the tea leaves are not utilized fully.

It is also known to carry out simultaneous extraction and aroma recovery from the tea leaves where the vapours generated during the extraction are condensed to recover volatile aroma compounds.

This method also gives relatively low yield. By increasing the time over which extraction is carried out, some improvement in yield can be achieved. However, this is accompanied by adverse effects on colour and flavour of tea extracted, resulting in tea with properties that are unacceptable to consumers.

EP 530 880 (Unilever, 1993) teaches a process of preparing tea volatiles wherein tea material, including black tea leaves, green tea leaves, yellow tea leaves or herb leaf material, is contacted with water vapour under distillation conditions and the obtained mixture of water vapour and tea flavour and/or aroma constituents is condensed, in which the condensation is effected by contacting the mixture of water vapour and tea flavour and/or aroma constituents obtained with cold, tea solids comprising material. It is also disclosed that the tea material can be pretreated with enzymes like cellulase and/or pectinase. In this process, the aroma-laden vapours are contacted with cold tea solids. Therefore, the processes of aroma recovery and the process of aroma add-back to tea must be carried within the same premises. Consequently, this process does not offer flexibility of using aroma recovered at one site for add-back to tea at another site.

GB 1 490 370 (Nestle, 1974) discloses recovery of aroma from spent leaves. In the process, the spent leaves are washed and treated with steam to strip the aromatics which are added to the concentrated extracts. The wash-liquor forms a secondary extract which is combined with the main extract before concentration, or may be partly used as the extraction liquid or the aqueous slurry medium. The slurry and extraction liquid may additionally be stripped of aromatics, either separately or combined prior to the leaf separation stage, the aromatics being combined with those produced from the spent leaves. The process described above offers economic advantage due to use of spent leaves. However, the yield of volatile aroma compounds is relatively low.

In view of the limitations in the prior art, one of the objects of the present invention is to overcome or ameliorate at least one of the disadvantages of the prior art, or to provide a useful alternative.

It is an object of the present invention to provide a process for recovery of volatile aroma compounds with relatively high yield.

Another object of the present invention is to provide a process of recovery of volatile aroma compounds in a relatively cost-effective manner.

Another object of the present invention is to provide a process for recovery of volatile aroma compounds that can be added to a tea product such that the tea product has consumer acceptable organoleptic properties.

Yet another object of the present invention is to provide a process for recovery of volatile aroma compounds at relatively high concentration such that the aroma volatiles can be transported across geographical locations offering flexibility in tea processing.

The present inventors have surprisingly found that it is possible to obtain a high yield of aroma without compromising quality by recovering aroma volatiles from spent tea material treated with an enzyme selected from cellulase, pectinase, amylase, β-glucosidase, primeverosidase or mixtures thereof.

### SUMMARY OF THE INVENTION

According to the present invention there is provided a process for recovering volatile aroma compounds from a tea material comprising the steps of:
a) incubating the tea material in an aqueous medium;
b) subjecting the incubated tea material to evaporation to obtain aroma-laden vapours;
c) condensing the aroma-laden vapours to recover an aroma condensate comprising volatile aroma compounds;
   wherein prior to step (a), the tea material has been subjected to a step of extraction of soluble solids; and wherein the aqueous medium in step (a) comprises an enzyme selected from cellulase, pectinase, β-glucosidase, primeverosidase or a mixture thereof.

According to another aspect there are provided volatile aroma compounds obtainable by the process of the present invention

According to another aspect, there is provided a tea composition comprising the volatile aroma compounds recovered from the process of the present invention.

### DETAILED DESCRIPTION OF THE INVENTION

### Tea Material

The term “tea material” as used herein refers to any material obtained from the plant Camellia sinensis var. sinensis and/or Camellia sinensis var. assamica or derived therefrom after processing such a plant material. The plant material includes tea leaf and bud. Some examples of the tea material according to the present invention include steamed and macerated tea material; steamed, macerated and dried tea material, macerated but unfermented tea material; macerated, unfermented and dried tea material; macerated and fermented tea material; macerated, fermented and dried tea material. The tea material can also be any primary, secondary or waste grade obtained by sorting any of the above tea materials.

It is an essential aspect of the present invention that the tea material is a spent tea material, i.e. the tea material has been subjected to a prior step of extraction of soluble solids. The step of extraction is typically carried out by contacting the tea material with water and separating the extract of soluble solids from the insoluble solids. The insoluble solids constitute the spent tea material, according to the present invention. The extraction may be cold extraction (temperature of 20 to 40° C.) or hot extraction (temperature from 40 to 90° C.). The extraction may be one-stage or multi-stage. It is within the scope of the present invention that the prior step of extraction of soluble solids is preceded by additional treatment of the tea material with enzymes. The extract of soluble solids is typically dried to obtain instant tea.

According to a preferred aspect, the tea material is subjected to sonication or comminution prior to or during the step (a) of incubating. Communition can be carried out, for example, using equipment including hammer mill, ball mill, Laurie tea processor, shredder, dicer, high shear mill or a combination thereof.

### Step (a): Incubation

The process of the present invention comprises a step of incubating the tea material in an aqueous medium.

The aqueous medium comprises an enzyme selected from cellulase, pectinase, β-glucosidase, primeverosidase or a mixture thereof. It is particularly preferred that the enzyme is selected from pectinase, β-glucosidase, primeverosidase or a mixture thereof.

The term cellulase refers to a class of enzymes produced chiefly by fungi, bacteria, and protozoans that catalyze the cellulolysis (or hydrolysis of cellulose). However, there are also cellulases produced by other types of organisms such as plants and animals. Several different kinds of cellulases are known, which differ structurally and mechanistically. The EC number for this group of enzymes is EC 3.2.1.4. Some commercially available enzymes of this class include CELLULASE AP® (Amano Enzymes, Inc.) and VISCOFERM® (Novozyme).

The active cellulase content of an enzyme is measured as enzyme activity on carboxymethyl cellulose (CMC) and expressed as carboxymethyl cellulose units, abbreviated as CMCU according to the standard practice in the field. The term CMCU refers to picomoles of glucose formed per minute using carboxymethyl cellulose as substrate and cellulase enzyme under standardized conditions. The protocol for estimation of CMCU is described by Lever (Analytical Biochemistry 47, 273-279, 1972).

The activity of the cellulase is preferably from 10⁵ to 10⁷, more preferably from 5×10⁵ to 5×10⁶, and most preferably from 5×10⁵ to 2×10⁶ CMCU per kg dry mass of the tea material.

The term pectinase refers to enzymes that break down pectin, a polysaccharide substrate that is found in the cell walls of plants. Pectinase can be extracted from fungi such as Aspergillus niger. Some commercially available enzymes of this class include VISCOZYME® (Novozyme) and EXTRACTASE® (Advanced Enzyme Technologies).

The activity of pectinase enzymes is measured in terms of Apple Juice Depectinase Units, commonly abbreviated as AJDU. It is based on the time required to depectinase an unclarified apple juice substrate at pH 3.5 and 45° C. The end point is determined by isopropyl alcohol precipitation. Activity is then determined by correlating depectinization time to the unknown sample with that of a pectinase standard of known activity using a defined single strength apple juice substrate according to procedure number 400.16 (dated May 22, 1992) of Solvay Enzymes, USA. Details are given in U.S. Pat. No. 6,132,727 (Rohde et al, 2000) which is incorporated herein by reference.

The activity of the pectinase is preferably from 10⁴ to 10⁷, more preferably from 0.5×10⁵ to 5×10⁶, and most preferably from 0.5×10⁵ to 2×10⁶ AJDU per kg dry mass of the tea material.

The tea material may be optionally wetted with water prior to addition of the aqueous medium to the tea material.

The ratio of the mass of water to the dry mass of the tea material during the step of incubating is preferably from 2:1 to 12:1, more preferably from 2:1 to 8:1, and most preferably from 3:1 to 6:1.

The step of incubating is for a period of preferably 5 to 200 minutes, more preferably from 15 to 150 minutes and most preferably from 30 to 90 minutes.

The step of incubating is at temperature between from preferably 5 and 70° C., more preferably between 15 and 60° C., and most preferably between 25 and 60° C.

It is preferred that the tea material is subjected to mixing during the step of incubating. The mixing may be intermittent or throughout the duration of incubation. Mixing may, for example, be by means of an impeller attached to a rotating arm or by rotating the container to achieve mixing by tumbling of the contents.

### Step (b): Evaporation

The step of incubating the tea material in an aqueous medium is followed by a step of subjecting the incubated tea material to evaporation to obtain aroma-laden vapours.

The step (b) is carried out at a pressure of preferably from 0.05 to 2 bar absolute, more preferably from 0.5 to 1.5 bar absolute and most preferably from 0.8 to 1.4 bar absolute.

The aroma-laden vapours are preferably generated in one of the following steps:
i. by adding water to the tea material and subjecting the resulting mixture to evaporation; or
ii. by contacting the tea material with water vapour under distillation condition.

### Preferred Embodiments of Step (i)

Water is added to the incubated tea material to prepare a slurry with the ratio of mass of water to the dry mass of tea material being preferably from 10 to 50, more preferably from 10 to 30, most preferably from 15 to 25. During evaporation, the ratio of mass of the water to dry mass of the tea material is maintained at preferably from 10 to 50, more preferably from 10 to 30 and most preferably from 15 to 25. The ratio is maintained by replenishing the water that is evaporated. The water can be replenished periodically or continuously. Evaporation the tea material is typically carried out in a closed heated tank. The tank can be provided with an agitator to keep the contents well mixed during aroma stripping.

The tea material is subjected to evaporation preferably in a batch or semi-batch mode. The evaporation may be carried out in any suitable evaporation equipment. The heat transfer may be direct or indirect. Indirect heating is provided by heat transfer medium without contacting the mixture. Indirect heating can be provided in various types of equipment such as jacketed vessels, or vessels provided with internal or external heating coils. The heating medium is usually water, steam or thermic fluid. Direct heating can be provided by injection of steam into the mixture. Heating may also be provided by electrical means such as Ohmic heating or electroresistive heating elements.

### Preferred Embodiments of Step (ii)

The tea material is contacted with water vapours under distillation condition. The amount of water vapour contacting with the mixture per unit dry mass of the tea material is preferably from 3 to 15, more preferably from 3 to 10 and most preferably from 3 to 8.

The water vapour is at a temperature preferably from 30 to 120° C., more preferably from 80 to 105° C. and most preferably from 90 to 100° C.

Any suitable equipment such as a packed bed can be used. The tea material is preferably supported on a porous plate or a mesh and acts as packing whilst the water vapours are passed through the bed in upward or downward direction.

### Step (c): Recovery of Aroma Condensate

The aroma-laden vapours that are obtained in the step (b) are condensed in the step (c). The step of condensation involves condensing the aroma-laden vapours to recover an aroma condensate comprising volatile aroma compounds.

The ratio of the mass of aroma condensate to the dry mass of the tea material is preferably from 0.1 to 25, more preferably from 3 to 20 and most preferably from 3 to 10.

The step of condensing aroma-laden vapours can be carried out in any suitable equipment. Examples of suitable equipment include, but are not limited to, shell and tube or double pipe heat exchangers. The heat exchanger is preferably vertically mounted. The aroma-laden vapours are preferably on the tube side whilst the cooling fluid is on the shell side or on the annulus side. The aroma-laden vapours preferably flow downwards.

According to a preferred aspect, the recovered aroma condensate may be further subjected to a step of concentration. The concentration of the aroma can be achieved by subjecting the feed to distillation, pervaporation, reverse osmosis and/or adsorption-desorption.

### Aroma Add-Back

Recovered aroma condensate, or further concentrated aroma condensate can be added back to tea products to enhance aroma. Aroma condensate may be sprayed onto a leaf tea product, instant tea product or a ready to drink product. A drying step may be required for leaf tea and instant tea to bring the moisture content down to stabilize the final product subsequent to aroma add-back.

The add-back of aroma condensate can be carried out, for example, by using equipment such as fluid bed dryer, tray dryer, vacuum dryer and/or freeze dryer for leaf tea and spray dryer, thin film dryer and/or freeze dryer for instant tea.

### EXAMPLES

The invention will now be demonstrated with examples. The examples are by way of illustration only and do not limit the scope of the invention in any manner.

Simultaneous Extraction and Recovery of Aroma of Tea Material Treated with Pectinase:

### Comparative Examples A, B, and C

50 g of black tea was incubated with 1% pectinase enzyme in 500 mL water for 60 min at a temperature of 25° C. Black tea was fresh, i.e., not subjected to a prior step of extraction of soluble solids. The enzyme activity was 1×10⁶ AJDU per kg dry mass of the black tea. The mixture was kept well mixed by agitating throughout the period of incubation. After 60 minutes, the mixture was heated to 90° C. in a water bath. The pressure was reduced to 500 mm Hg during the extraction stage to flash off the aroma volatiles. The heated mixture was strained through four layers of muslin cloth to separate the liquor from the insoluble spent leaf. 330 mL of tea liquor having a brix of 3.2 was collected. 122 g of spent leaf having moisture content of 72% was obtained.

The flashed vapours from the extraction step were routed through a condenser to condense the aroma vapours. Chilled water at 6° C. was used as the cooling utility in the condenser. 12.5 mL of aroma condensate was obtained. The total organic carbon content of the condensate was used as a measure of the total concentration of aroma compounds in the captured aroma condensate.

130 mL of the tea liquor obtained was dried and converted into hot water soluble instant tea powders. This was done by heating the liquor in a water bath maintained at 70° C. while simultaneously subjecting the liquor to a vacuum of 670 mm Hg. The instant tea powders so produced were used for making an end cup by adding 1 g of powder to 60 mL of hot water and 40 mL of hot milk. A chromameter (Minolta CR400) was used to measure ‘a’ value for the end cup, a measure of the red colour of the tea. A drop in the ‘a’ score implies a less red tea.

Similar experiments were conducted for extraction times of 30 minutes and 60 minutes. The data from the above set of experiments are given in Table 1.

TABLE 1

| | | Total Aroma, | |
|---|---|---|---|
| Example | Extraction | (mg/kg dry mass | ‘a’ score of |
| No | time (minutes) | of tea material) | instant tea |
| A | 10 | 47.7 | 6.69 |
| B | 30 | 168.7 | 6.22 |
| C | 60 | 250.9 | 4.87 |

From these results it is clear that when the recovery of aroma is simultaneous with the extraction of soluble solids, the amount of total aroma condensate can be increased by increasing the time of extraction. However the increase in aroma condensate is at the cost of loss of quality of extracted tea solids, as indicated by decrease in redness of tea.

Spent Tea Material without Enzymatic Treatment:

### Comparative Example D

353 gm of fresh black tea, having moisture of 7.82%, was mixed with 3520 mL water. The mixture was heated at 90° C. for 10 minutes while maintaining good mixing. The mixture was then filtered through four layers of muslin cloth to separate the extract liquor from the insoluble spent leaf. 2675 mL of extract tea liquor having brix of 3% was obtained. 832 g of spent leaf having moisture of 70% was obtained. The entire spent leaf was taken in a round bottom flask of 10 L capacity. 4400 mL water was added to it (to make up the total water to twenty times the dry mass). This slurry was boiled at atmospheric pressure for 6 hrs. The boil-off rate was maintained at 250 mL/hour. The vapours thus formed, were routed through a condenser with a cooling utility at 6° C. 1500 mL of condensate was obtained. The total organic carbon content of the condensate was measured.

Fresh Tea Material Treated with Enzyme Prior to Extraction:

### Comparative Example E

3.5 g of pectinase enzyme was mixed with 350 g of black leaf tea and 1400 g of water. The enzyme activity was 1×10⁶ AJDU per kg dry mass of the black leaf tea. The mixture was incubated at 55° C. for 60 minutes under well mixed conditions. In this case, the tea material was not subjected to a step of extraction of soluble solids prior to subjecting the tea material to evaporation. Further steps were identical to that of Comparative Example D.

Spent Tea Material Incubated with Aqueous Medium Comprising Pectinase:

### Example 1

352.1 g of black tea material, having moisture of 7.82%, was mixed with 3520 mL water. The mixture was heated at 90° C. for 10 minutes and then filtered through four layers of muslin cloth to separate the extract tea liquor from the insoluble spent leaf. 2690 mL of tea liquor having brix of 3% was collected. 854 g of spent leaf having moisture content of 69.81% was collected. This spent leaf was mixed with 430 mL water to bring the total water to dry mass ratio of the mixture to 4. Pectinase enzyme was added such that the activity was 1×10⁶ AJDU per kg dry mass of the tea material and the mixture was incubated at 55° C. for 1 hour. After incubation, 4125 mL of water was added. Further steps were identical to that of Comparative Example D.

### Quantity of Total Aroma Obtained

The results of example 1 and Comparative Examples D and E are given in Table 2 in terms of total aroma recovered.

TABLE 2

| | Prior extraction | | |
|---|---|---|---|
| Example | of soluble solids | Enzyme | Total Aroma (mg/kg dry |
| No | from tea material | treatment | mass of tea material) |
| D | Yes | No | 229 |
| E | No | Yes | 374 |
| 1 | Yes | Yes | 1266 |

In all examples above, the ‘a’ score of tea was 6.69

From these results, it is clear that there is a relatively small increase in total aroma when the enzyme is added during extraction according to prior art process, as compared to the process where no enzyme is added. However, substantial increase in total aroma is surprisingly obtained when spent tea material is incubated in an aqueous medium comprising pectinase according to the process of the present invention.

### Quality of Aroma Obtained

### Preparation of Tea Beverage

Aroma condensate recovered in example 1 and Comparative Examples D and E was added to a base instant tea powder. The volumes of aroma condensates added in each case were adjusted such that the amount of aroma volatiles added to was 3 mg/L (on a total organic carbon content basis). For each case, a tea beverage was prepared using the following procedure. Three batches of 1 L of hot milked tea was prepared by adding 9 g of instant tea powder and 50 g of sugar to 600 mL of hot water and 400 mL of hot milk to each.

The prepared teas were served one cup at a time to 13 trained panellists separately in isolated cabinets. The panellists evaluated the samples on tea aroma, green aroma & fresh aroma and scored each on a standard scale of 0 to 10. The results of Comparative testing are given in Table 3.

TABLE 3

| Sensorial | Increase in Score - | Increase in Score - |
|---|---|---|
| Parameter | (Ex E − Ex D) | (Ex 1 − Ex D) |
| Tea Aroma | 0.19 | 0.38 |
| Fresh Aroma | 0.28 | 0.52 |

It can be seen from the results that the quality of tea obtained after adding back recovered aroma according to the process of present invention is equivalent or higher than the tea products made according to the prior art processes.

It will be appreciated that the above examples clearly demonstrate the mode in which the invention can be practiced. Further, the examples go on to show that the process of the present invention is able to provide tea aroma at relatively high yield in a relatively cost-effective manner and that the aroma prepared by the process of the present invention, when added back to a tea product, provides a tea beverage with acceptable organoleptic properties.

1. A process for recovering volatile aroma compounds from a tea material comprising the steps of:
a) incubating the tea material in an aqueous medium;
b) subjecting the incubated tea material to evaporation to obtain aroma-laden vapours;
c) condensing the aroma-laden vapours to recover an aroma condensate comprising volatile aroma compounds;
wherein prior to step (a) the tea material has been subjected to a step of extraction of soluble solids; and wherein the aqueous medium in step (a) comprises an enzyme selected from cellulase, pectinase, β-glucosidase, primeverosidase or a mixture thereof.

2. A process as claimed in claim 1 wherein said enzyme is selected from pectinase, β-glucosidase, primeverosidase or a mixture thereof.

3. A process as claimed in claim 1 wherein the activity of said pectinase is from 10⁴ to 10⁷ Apple Juice Depectinase Units per kg dry mass of the tea material.

4. A process as claimed in claim 1 wherein the amount of said cellulase is from 10⁵ to 10⁷ carboxymethyl cellulose units per kg dry mass of the tea material.

5. A process as claimed in claim 1 wherein the activity of said □-glycosidase is from 10² to 10⁵ units per kg dry mass of the tea material.

6. A process as claimed in claim 1 wherein the activity of said □-primeverosidase is from 10² to 10⁵ units per kg dry mass of tea material.

7. A process as claimed in any one of the preceding claim 1 wherein the step (b) is carried out at a pressure of from 0.05 to 2 bar absolute.

8. A mixture of volatile aroma compounds obtainable by the process as claimed in claim 1.

9. A tea composition comprising the mixture of volatile aroma compounds as claimed in claim 8.
